(19) United States
(12) Patent Application Publication
(10) Pub. No.: US 2016/0253752 A1
(43) Pub. Date: Sep. 1, 2016

(54) METHOD AND SYSTEM FOR INTERNAL ANALYSIS OF LOAN INSTRUMENTS

(71) Applicant: Keith BENNETT, Eagle River, AK (US)

(72) Inventor: Keith BENNETT, Eagle River, AK (US)

(73) Assignee: Denali Alaskan Federal Credit Union, Anchorage, AK (US)

(21) Appl. No.: 15/152,153

(22) Filed: May 11, 2016

Related U.S. Application Data
(63) Continuation of application No. 13/736,013, filed on Jan. 7, 2013.
(60) Provisional application No. 61/583,557, filed on Jan. 5, 2012.

(51) Int. Cl. G06Q 40/02

(52) U.S. Cl. CPC G06Q 40/025

(57) ABSTRACT

A system and method for processing loan applications is provided. An embodiment of the system provides complete control over an automated loan review process. All loans and loan applications entered in the system can be automatically entered into the loan review system and reviewed for compliance with predetermined policies and procedures. The loan application data associated with each loan can be obtained by a server communicating with a database over a network, and the loan can be assigned to a loan review queue based on its loan application data. The server may obtain user input via a client in communication with the server over the network, and may process the loan based on the obtained user input and the loan application data. Statistics related to the loan applications being processed may be collected and organized for tracking applications and identifying trends.

### CROSS-REFERENCE TO RELATED APPLICATION

The present application is a continuation of, and claims the benefit of the filing date of U.S. patent application Ser. No. 13/736,013, filed Jan. 7, 2013, entitled “METHOD AND SYSTEM FOR INTERNAL ANALYSIS OF LOAN INSTRUMENTS,” which claims the benefit of U.S. Provisional Patent Application Ser. No. 61/583,557, filed Jan. 5, 2012, entitled, “METHOD AND SYSTEM FOR INTERNAL ANALYSIS OF LOAN INSTRUMENTS.” Each of the foregoing is hereby incorporated herein in its entirety by reference thereto.

### BACKGROUND

Financial institutions conventionally process loan applications through a multiple stage review process. Often each review stage can be completed at different locations using a combination of paper files and electronic communication.

Currently, loan applications for various financial institutions are audited and processed with a detailed review. Reviewers currently scan through the loan packets and manually complete a review form, making notations of any areas within the loan documentation that has exceptions to the standard lending policies and/or procedures.

If a reviewer finds exceptions, the loan packet is then forwarded to a manager for further review. If the manager agrees with the reviewer's assessment then the loan packet is recorded by the manager and forwarded to the executive manager of the loan officer. The executive manager is then tasked with addressing the exceptions with the loan officer and works to resolve identified exceptions.

Thus the current process is labor-intensive and extremely time-consuming, lacks a robust tracking system to ensure that all loans are being reviewed, has no means of quantifying exceptions, defining trends, or validating that exceptions have been addressed, and fails to provide a means of monitoring, or successfully managing, the underlying risks with regards to loans being underwritten outside of defined guidelines and policies. Accordingly, there is a need in the art for a paper-less means of overseeing the loan review process, ensuring all loans are captured and exceptions are tracked.

### BRIEF DESCRIPTION OF THE DRAWINGS

The foregoing and other aspects of various embodiments of the present invention will be apparent through examination of the following detailed description thereof in conjunction with the accompanying drawing figures in which similar reference numbers are used to indicate functionally similar elements.

FIG. 1 is a functional block diagram illustrating components of an exemplary system according to an embodiment of the present invention.

FIG. 2 is a simplified flow diagram illustrating an exemplary loan review method according to an embodiment of the present invention.

FIG. 3 is a simple block diagram illustrating loan review queues for an exemplary loan review system according to an embodiment of the present invention.

FIG. 4 illustrates an exemplary interface displaying a loan review officer's queue on an exemplary client device according to an embodiment of the present invention.

FIG. 5 illustrates an exemplary interface displaying a loan review interface on an exemplary client device according to an embodiment of the present invention.

FIG. 6 is a simple block diagram illustrating exemplary information collected for loan review system statistics according to an embodiment of the present invention.

FIG. 7A illustrates an exemplary interface displaying a loan review status report on an exemplary client device according to an embodiment of the present invention.

FIG. 7B illustrates an exemplary interface displaying a loan review status report on an exemplary client device according to an embodiment of the present invention.

FIG. 7C illustrates an exemplary interface displaying a loan review status report on an exemplary client device according to an embodiment of the present invention.

FIG. 7D illustrates an exemplary interface displaying a loan review status report on an exemplary client device according to an embodiment of the present invention.

FIG. 8 is a simple block diagram illustrating exemplary records for a database organizing the records of the loan review system according to an embodiment of the present invention.

### DETAILED DESCRIPTION

A system and method for overseeing the loan review process is provided. Financial institutions may manage the inherent risk in consumer lending by quickly identifying trends and areas where further training can be justified. An embodiment of the disclosed system may provide complete control over an automated loan review process. All loans and loan applications entered in the system can be automatically entered into the loan review system and reviewed for compliance with the predefined policies and procedures. Each loan can be assigned a queue associated with a loan review officer for review. Loans identified with discrepancies or issues during the initial review can be escalated to a manager and potentially returned to the originating loan officer for correction or additional input. At each stage, the individual reviewer may enter comments. Discrepancies can be rated for risk so that high-risk applications can be easily identified and tracked. Report data and statistics can be utilized to assist in managing the risk in consumer lending by quickly identifying trends and areas where further training can be justified.

A method for reviewing loan applications comprising may include assigning a loan application uploaded to a database at a server to a reviewing entity, receiving at the server review results from the reviewing entity, rating the review results with a risk factor, disposing the loan according to the review results, and sending from the server a notification to a loan entity with the review results upon loan finalization. As used herein, an entity may be understood to include a person, a computer, a processor, etc.

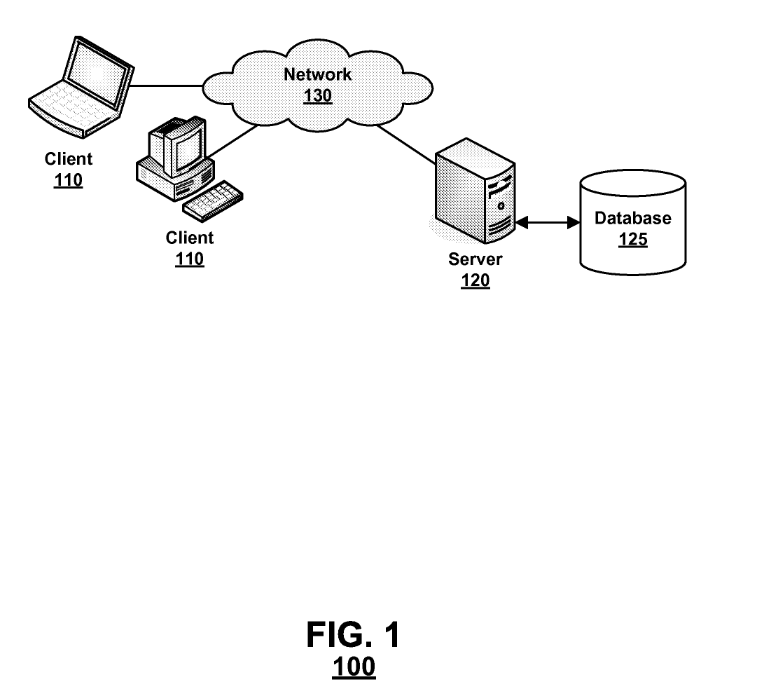

FIG. 1 is a functional block diagram illustrating components of an exemplary system 100 according to an embodiment of the present invention. As shown in FIG. 1, the system 100 may include one or more clients 110 accessing at least one server 120 via a network 130. The server 120 can be a network server connected to a client 110 via the network 130. The server 120 may manage operation of the loan review system for users connected to the system via the clients 110. The server 120 can be a single, stand-alone server, it may consist of multiple servers wherein each server performs a specific function in the system, or it may consist of redundant servers that provide reliability for multiple individuals accessing multiple aspects of the system at one time. The server 120 may access a database 125 or other memory storage storing loan records and other information used to facilitate the loan review process. The network 130 can be a wired or wireless network that may include a local area network (LAN), a wide area network (WAN), the Internet, or any other network available for accessing the server 120 via the client 110.

A user may access the loan review system from the client 110 via a user interface capable of accessing and displaying the loan review system. The client can be any device that facilitates a user accessing the server 120 via a user interface for example a personal computer, laptop, tablet device, mobile handheld computing device, or other network accessible device. The user interface can be a program or application or may comprise middleware that acts as a frontend to or otherwise facilitates access to the loan review system. The user may interact with the user interface through an input device, such as by inputting a selection as with a mouse, a keyboard, a handheld controller, or a screen tap. The user may observe the response to the selection on an output device or display. In accordance with an aspect of the invention, the user interface may run in a browser window displayed on the client 110 and controlled by the user, the browser window connected to and receiving instructions from the server 120. In another aspect of the invention, the user interface may run in an application window for an application installed on the client 110 and controlled by the user. When a user accesses the interface, the client 110 may communicate with the server 120. The server 120 may return information to the client 110 to facilitate the user's interaction with the loan review system. The client 110 may display one or more aspects of the loan review system supported by one or more databases 125 accessible by the server 120. Access to each interface or a subset of interface screens can be restricted to certain loan officers, to certain managers, or to other individuals as set by a system administrator.

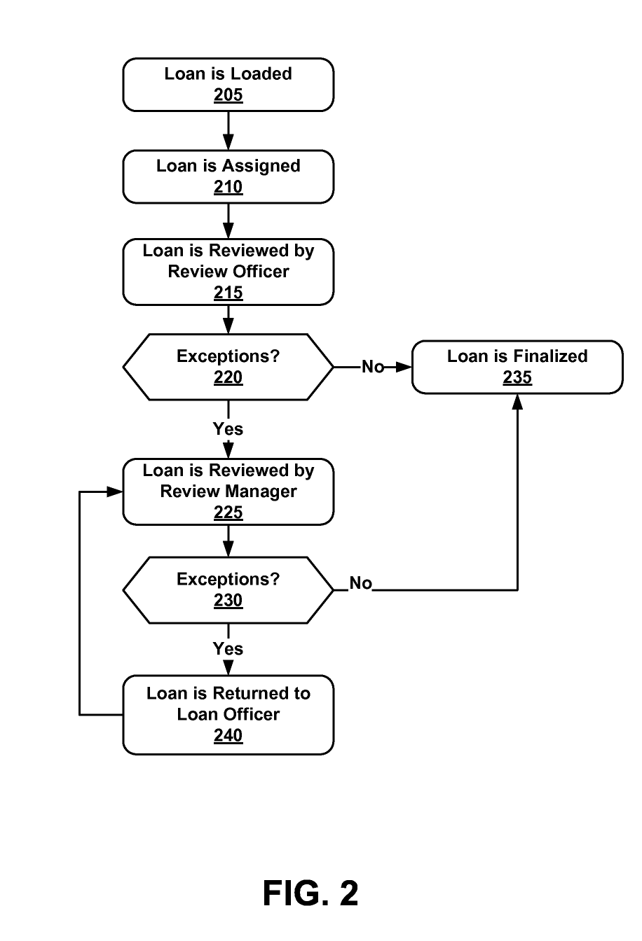

FIG. 2 is a simplified flow diagram illustrating an exemplary loan review method according to an embodiment of the present invention. As shown in FIG. 2, a new loan application may first be loaded into a loan review database (block 205). The loan review system may support loading and review of multiple different types of loan applications including secured consumer, unsecured consumer, visa, real estate, and/or business loans. According to an embodiment, the loans loaded in the loan review database can be extracted from another database or system. Whether some or all of the loan information is extracted from a first database or system, or a new loan is created and loaded into the review database, the loaded loan application should include sufficient information to support the review of the loan.

According to an embodiment, all loans entered into the loan review system can be reviewed or a subset of the entered loans can be assigned for review. For example, all loans of a specific type, from a specific branch, or from a specific loan officer can be assigned for review. According to an embodiment, only a percentage of loans can be assigned for review, and that percentage can be variable. For example, only a percentage of all loans or of loans of a certain type can be assigned for review. The percentage of loans assigned for review can be determined by multiple factors, including, for example, by a specific loan officer or branch.

Loans loaded into the loan review system may then be assigned to a review officer (block 210). The loans assigned to each review officer can be stored in a loan review queue associated with that officer. The assignment of a loan can be based on a number of factors, including for example the number of loans awaiting review in the review officer's queue, the type of the loan, the qualifications of the review officer, or according to other parameters and algorithms.

A loan officer may then review the loans in their assigned queue (block 215). Each loan officer may have access only to his or her queue and may only review the loans assigned to them. According to an embodiment, each loan can be reviewed for a number of different conditions, which can be presented as a checklist of conditions. The loan review officer may review each item in the checklist and make comments or notes as appropriate. The conditions in the checklist may vary, for example, depending on the loan type, the loan officer, or the branch. The conditions on the checklist may include essential or required items, general items, collateral or unsecured items, or other types of conditions depending on the loan type or another loan parameter. A checklist can be automatically generated for each loan application. If an essential or required item is missing, or another issue of importance is identified during the review, the loan can be marked as having an exception. According to an embodiment, the conditions or exceptions can be assigned a point value based on the importance or significance of the condition. Then if the loan has a total point value over a predetermined threshold, the loan can be identified as having an exception or requiring additional review. A subset of loans having a point value below the predetermined threshold may additionally be identified for additional review, for example, to meet a predetermined requirement for the number of loans reviewed, or to spot check the review process.

If no exceptions are found during the review process (block 220), the loan can be finalized and moved to a no exceptions queue (block 235). However if a reviewed loan is determined to have an exception (block 220), the loan can be passed to a review manager for additional review (block 225). Each review manager may have access only to his or her queue and may only review the loans assigned to them or assigned to loan officers they manage. During the additional review, a review manager may send comments or questions to the original loan review officer. For example an email or other message can be transmitted to the original loan review officer with comments and a link to the loan in the loan review system. Comments and notes on the loan review can be saved for future reference. According to an embodiment, the loan review manager may set or change a point value identifying the risk of the loan.

If the review manager clears the previously identified exceptions or otherwise determines that the loan should be successfully passed through the review process (block 230), the loan can be finalized and moved to a no exceptions queue (block 235). However, if the review manager verifies one or more exceptions (block 230), the loan can be returned to the loan officer for additional processing (block 240). A loan officer may then receive a message notification including a link to the loan in the review system indicating that the loan requires additional processing.

The loan officer may then review any loans that were returned from a review manager. The loan officer may correct or acknowledge the exception and provide comments or additional information. The loan officer should address each exception raised by the review manager, for example by providing supplemental information or providing an explanation. The updated loan may then be returned to the review manager for additional review and finalized (block 225-235).

Upon finalization of a loan, the loan officer and the loan officer's manager may receive an email notification or other message indicating the successful processing of the loan. Additionally, the loan review statistics can be updated, including, for example, the statistics provided by loan group, loan officer, branch, reviewing officer, etc.

Certain aspects of the loan review system can be set or controlled by a system administrator. For example, the loan assignment parameters, thresholds, and checklist conditions can be set or adjusted by a loan review system administrator. An administrator may also reset a loan review to clear the notes and processing associated with the review of the loan. An administrator may additionally manage user access and access permissions for the various interfaces in the loan review system, setting different permissions for different aspects of the review system. The administrator may add or edit loan groups, loan types, loan conditions, branches, and personnel within the loan review system.

Various reports can be run that describe the status of loans reviewed via the system. For example, reports may show the number of loans and/or a list of loans with no exceptions, finalized loan reviews with exceptions, loans awaiting review or response, loan reviews overruled by a review manager, etc. Reports can be periodically transmitted to system management or other relevant system users. Alternate information collected by the loan review system may additionally be pulled or exported for customized reports. The reports and statistics can be sortable by a number of different fields including for example date, branch, loan officer, review officer, account number, etc. thereby facilitating identification of trends in the officers, branches, or accounts that tend to have high risk loans.

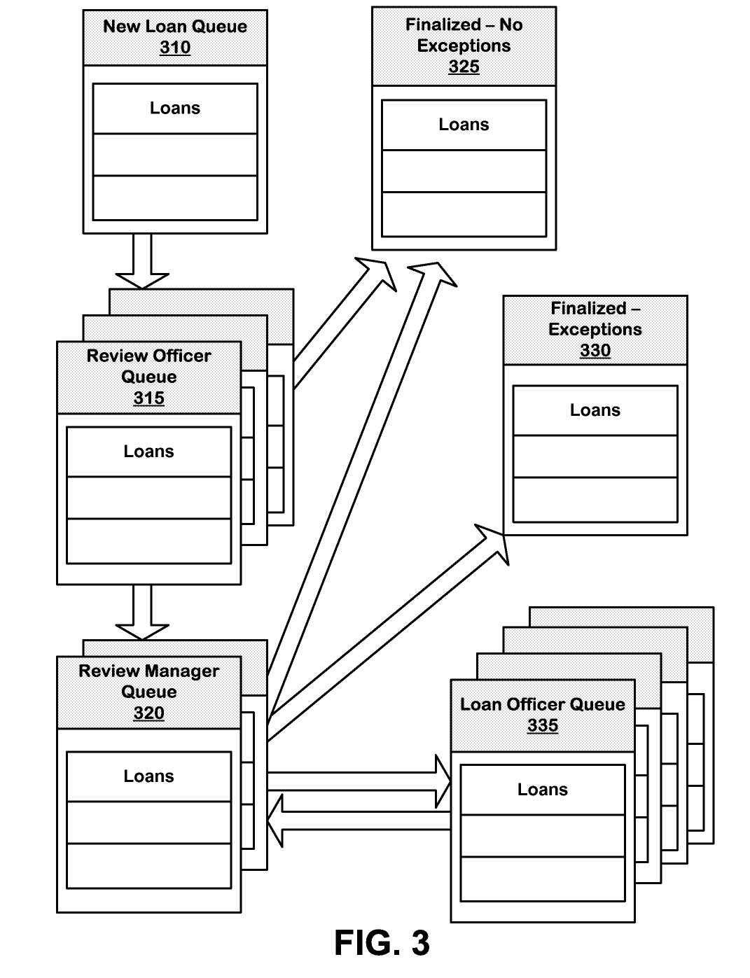

FIG. 3 is a simple block diagram illustrating loan review queues for an exemplary loan review system according to an embodiment of the present invention. As shown in FIG. 3, the loan review system may include the following queues implemented to store and organize the loan applications:

A new loans queue 310 may hold loans added to the loan review system and awaiting assignment to a loan review officer.

A loan review officer's queue 315 may hold loans assigned to the loan review officer and awaiting review. Each individual loan review officer may have an assigned queue accessible by the loan review officer via a user interface at a client device. An individual review officer's queue can be closed, either temporarily or permanently, such that no new loans can be assigned to the review officer. If temporarily closed, a system administrator may re-open the review officer's queue. If a loan officer's queue has outstanding loans awaiting review, the loan officer and/or the loan officer's manager may periodically receive an email notification identifying the outstanding or un-reviewed loans.

A loan review manager's queue 320 may hold loans identified as having exceptions and requiring additional review. Each individual loan review manager may have an assigned queue accessible by the loan review manager via a user interface at a client device.

A finalized with no exceptions queue 325 may hold loans reviewed and approved without exceptions.

A finalized with exceptions queue 330 may hold loans reviewed and finalized with exceptions. The loans in this queue may have had exceptions that were cleared or may have exceptions that were not deemed significant or high risk.

A loan officer's queue 335 may include loans identified as having exceptions and requiring additional response. Each individual loan officer may have access to a queue as needed, via a user interface at a client device.

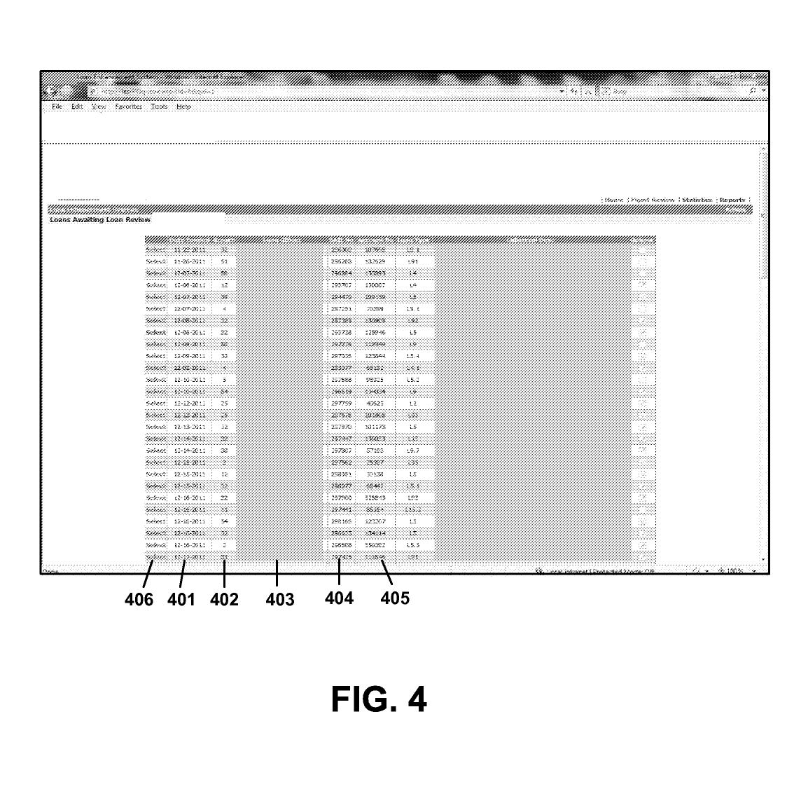

FIG. 4 illustrates an exemplary interface displaying a loan review officer's queue on an exemplary client device according to an embodiment of the present invention. A user may access the loan review officer's interface to access and review loans awaiting the loan review officer's review. As shown in FIG. 4, a queue interface may display the pending loans including the date the loan was funded 401, the branch the loan originated from 402, the loan officer that approved the loan 403, a database identifier 404, an account number for the loan 405, and other information relevant to each loan. The queue interface may additionally provide links to the review interface for each loan 406.

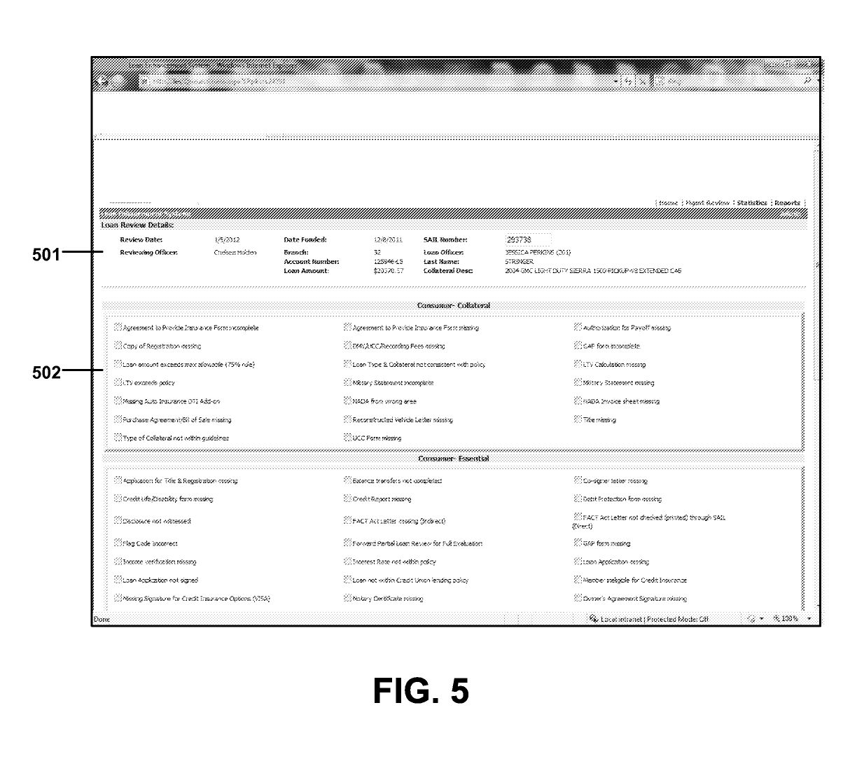

FIG. 5 illustrates an exemplary interface displaying a loan review interface on an exemplary client device according to an embodiment of the present invention. A user may access the loan review interface to review a loan. As shown in FIG. 5, a review interface may display loan details 501 as well as a checklist of the conditions 502 to be reviewed by the loan review officer. The review interface may additionally provide a link to submit the loan for additional review or for finalization to the no exceptions queue.

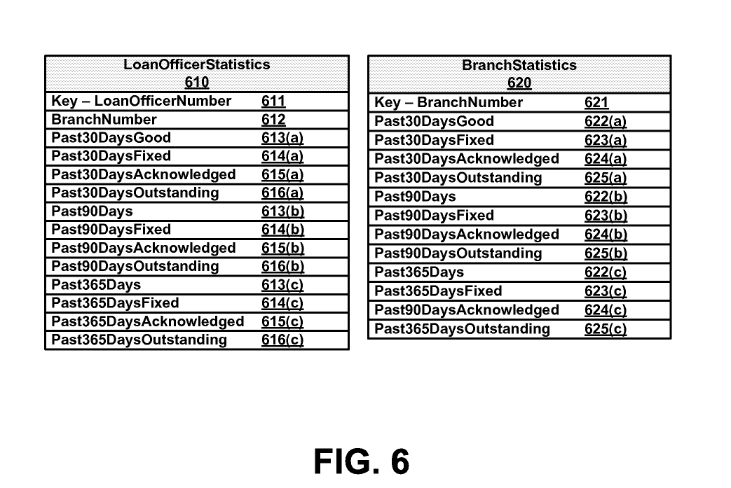

FIG. 6 is a simple block diagram illustrating exemplary information collected for loan review system statistics according to an embodiment of the present invention. As shown in FIG. 6, the loan review system may include modules implemented to collect, store and organize the following loan review system statistics:

Loan officer statistics 610 may include a database id 611, an associated branch identifier 612, loans originating with the loan officer that have passed review without exceptions in various time periods 613(a)-(c), loans that have been fixed or adjusted during review in various time periods 614(a)-(c), loans that the loan officer has acknowledged and explained exceptions in various time periods 615(a)-(c), and outstanding loans requiring additional review in various time periods 616(a)-(c).

Branch statistics 620 may include a database id 621, loans originating from that branch that have passed review without exceptions in various time periods 622(a)-(c), loans that have been fixed during review in various time periods 623(a)-(c), loans that the loan officer has acknowledged and explained exceptions in various time periods 624(a)-(c), and outstanding loans requiring additional review in various time periods 625(a)-(c).

Additional statistics and information can be collected by the loan review system. For example, statistics may additionally be collected for each loan group and reviewing officer, including information identifying the loans that have been reviewed in the system in various time periods.

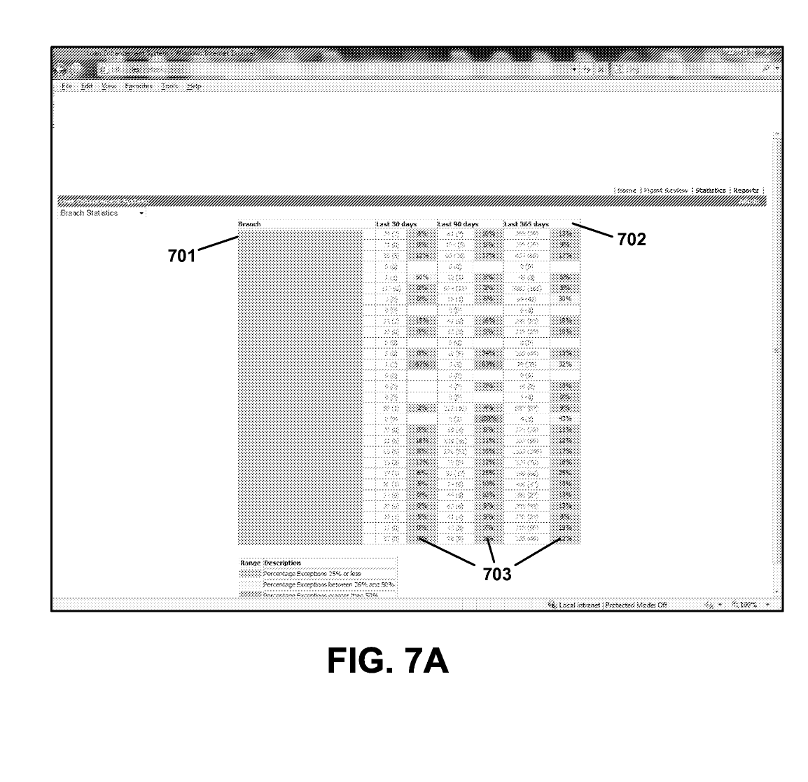

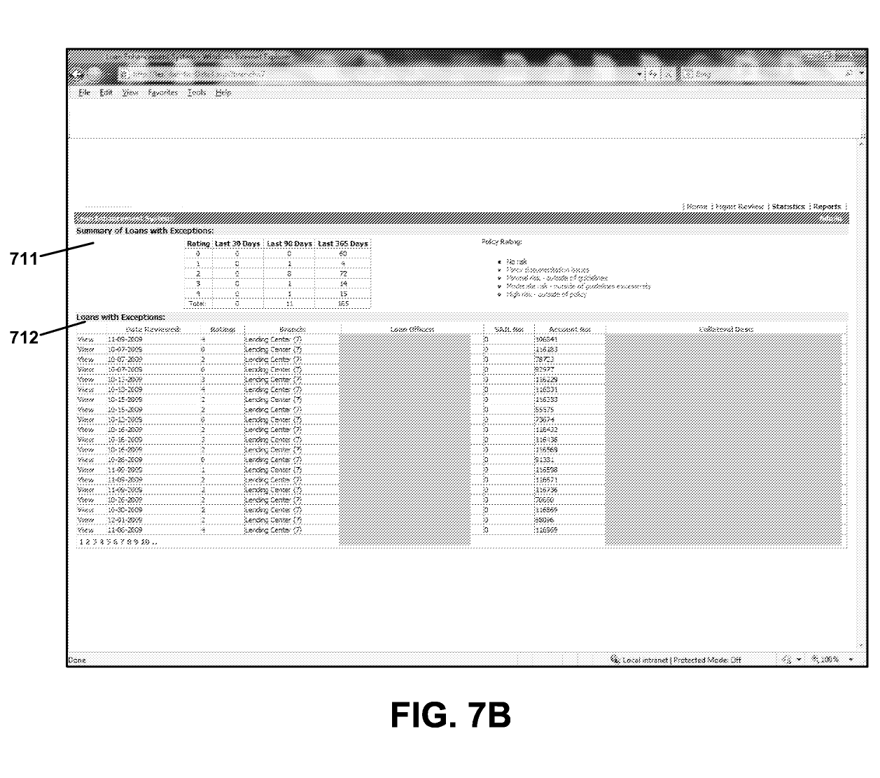

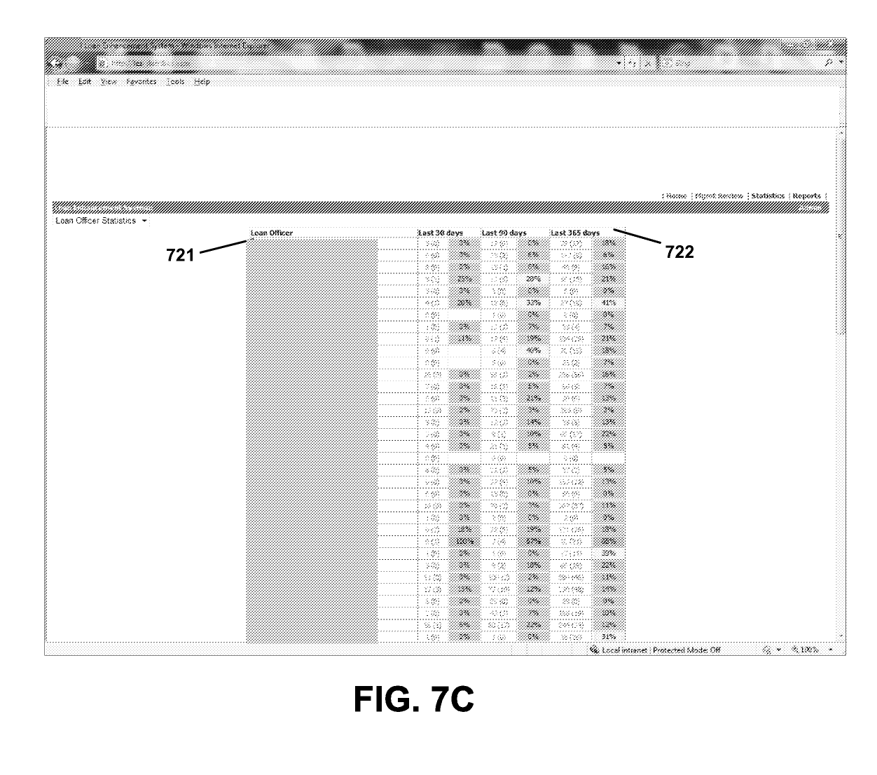

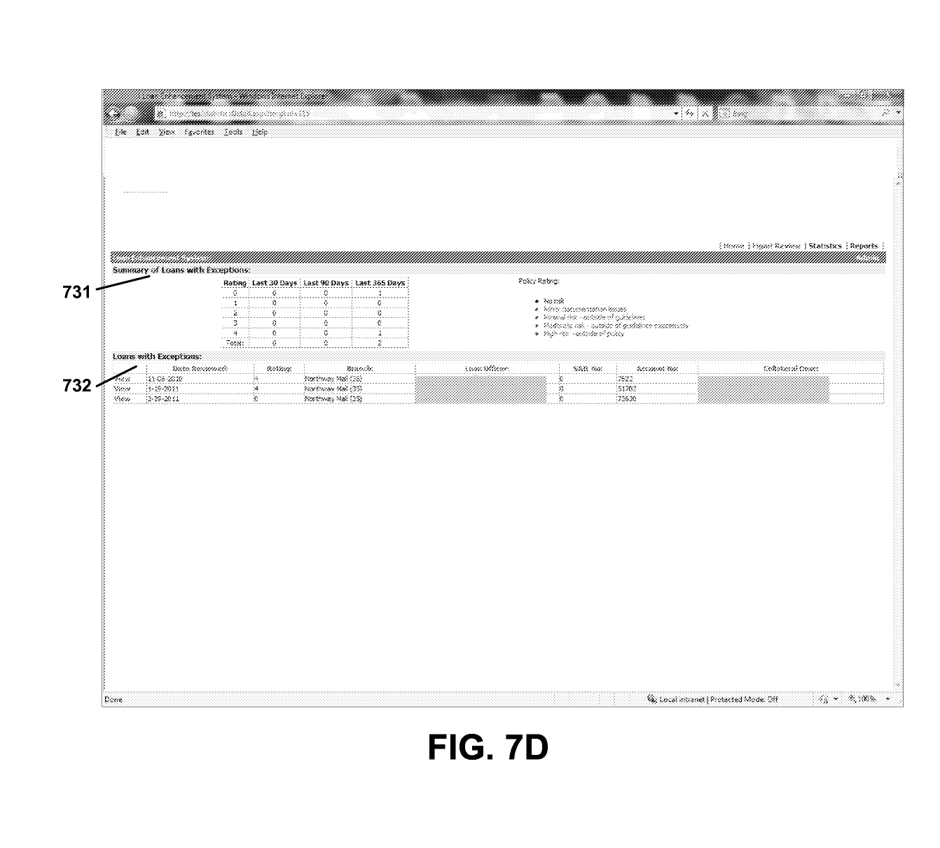

FIGS. 7A through 7D illustrate exemplary interfaces displaying loan review status reports and statistics on an exemplary client device according to an embodiment of the present invention. A user may access the loan review status report to review the status of a loan or statistics tracked by the loan review system. Reports may include links to additional interfaces that allow the user to retrieve additional information.

As shown in FIG. 7A, an institutional statistics report may display a summary of the loans reviewed arranged by time period 702 and branch 701 and identified by the number and percentage of loans 703 of a specific category. A link to the individual report for each of the identified branches can be provided as part of the report interface.

As shown in FIG. 7B, a loan review status report may display a summary of the loans reviewed for a specific loan group arranged by time period and a listing of loans identified as having a specific condition or of a specific category. For example, FIG. 7B illustrates an exemplary summary of the loans reviewed and marked as having exceptions including a summary of such loans in several different time periods 711 and the details of each loan in the category 712.

As shown in FIG. 7C, a loan review status report for loan officer statistics may display a summary of the loans originating from each officer 721 that were reviewed and finalized with and without exceptions arranged by time period 722.

As shown in FIG. 7D, a loan review status report may display a summary of the loans reviewed by a specific branch arranged by time period and a listing of loans identified as having a specific condition or of a specific category. For example, FIG. 7B illustrates an exemplary summary of the loans reviewed and marked as having exceptions including a summary of such loans in several different time periods 731 and the details of each loan in the category 732.

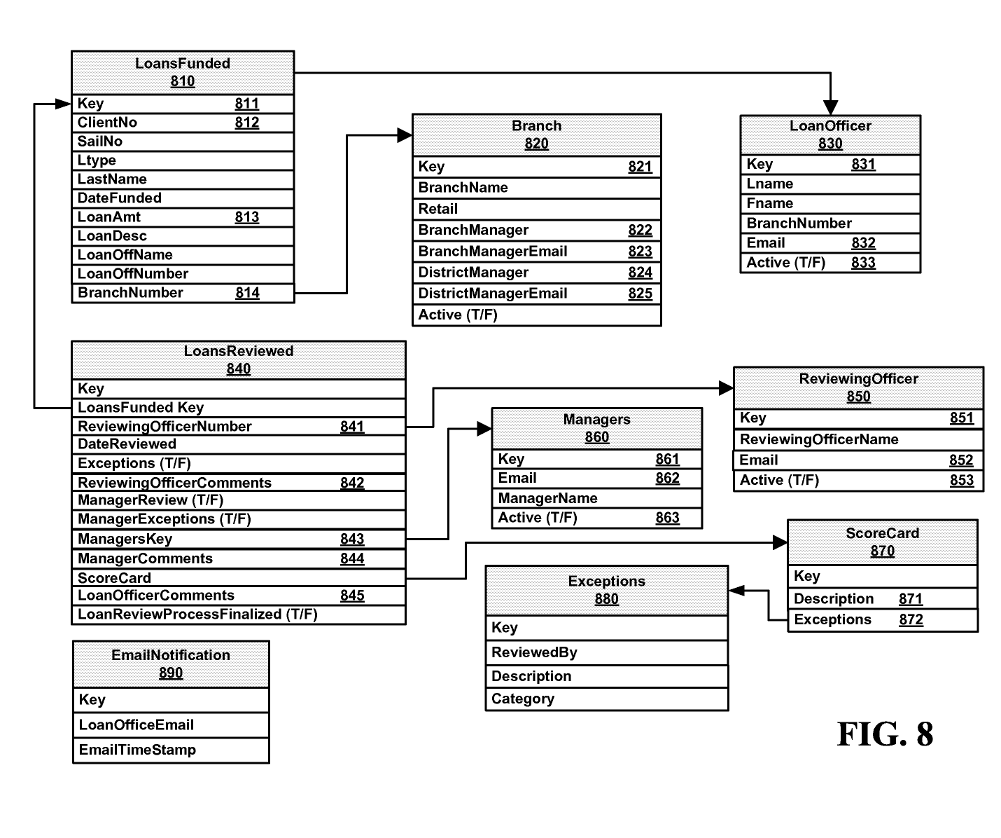

FIG. 8 is a simple block diagram illustrating exemplary records for a database organizing the records of the loan review system according to an embodiment of the present invention. As shown in FIG. 8, the loan review system may include the following records implemented to manage, store and organize the loan review process. Each record may include an identification of other associated records as indicated.

A loan record 810 may include information about the individual loan including, for example, the client id 812, the loan amount 813, and the originating branch id 814.

A branch record 820 may include a branch identifier 821, the personnel working at or with the branch including a branch and district manager 822, 824, and contact information for the identified personnel 823, 825.

A loan officer record 830 may include a loan officer id 831, contact information 832, and the status 833 of the loan officer.

A review record 840 for each loan reviewed may include information about the review including the reviewing officer 841, the reviewing manager 843, and any comments input during the course of the review 842, 844, 845.

A review officer record 850 may include an identification of the review officer 851, the status of the review officer 853, and contact information 852.

A review manager record 860 may include an identification of the review manager 861, the status of the review officer 863, and contact information 862.

A score card record 870 may include information about the risk assigned to a loan based on the review 871 and the identified exceptions 872.

An exception record 880 may identify items that need follow up or that were followed up on by a loan officer, a reviewing officer, or a review manager.

A record of the email notifications 890 may track the email notifications or other messages sent by the system, including for example a notification that loans are awaiting user review.

The foregoing discussion identifies functional blocks that can be used in internal loan analysis systems constructed according to various embodiments of the present invention. In practice, these systems can be applied in a variety of devices, such as personal computing systems and/or mobile devices. In some applications, the functional blocks described hereinabove can be provided as elements of an integrated software system, in which the blocks can be provided as separate elements of a computer program. Other applications of the present invention can be embodied as a hybrid system of dedicated hardware and software components. Other implementations also can be used.

Moreover, not all of the units, blocks, or modules described herein need be provided or need be provided as separate units. In one or more embodiments, some or all of the described units can be integrated, can be implemented in separate systems, or may not be implemented at all. Such implementation details are immaterial to the operation of the present invention unless otherwise noted above. Additionally, although FIG. 2 illustrates an exemplary method, the order of operations can be altered or adjusted, and operations can be added or some operations skipped entirely.

Some embodiments can be implemented, using a non-transitory computer-readable storage medium or article which may store an instruction or a set of instructions that, if executed by a processor, may cause the processor to perform a method in accordance with the disclosed embodiments. The exemplary methods and computer program instructions can be embodied on a non-transitory machine-readable storage medium. In addition, a server or database server may include machine-readable media configured to store machine executable program instructions. The features of the embodiments of the present invention can be implemented in hardware, software, firmware, or a combination thereof and utilized in systems, subsystems, components or subcomponents thereof. The machine-readable storage media may include any medium that can store information. Examples of a machine-readable storage medium include electronic circuits, semiconductor memory device, ROM, flash memory, erasable ROM (EROM), floppy diskette, CD-ROM, optical disk, hard disk, fiber optic medium, or any electromagnetic or optical storage device.

While the invention has been described in detail above with reference to some embodiments, variations within the scope and spirit of the invention will be apparent to those of ordinary skill in the art. Thus, the invention should be considered as limited only by the scope of the appended claims.

We claim:

1. A system for processing loan applications, comprising:
means for obtaining loan application data associated with at least one loan application;
means for assigning the loan application to a loan review queue based on the loan application data;
means for obtaining a user input from at least one client having a user interface configured to access the loan review queue and display loan application data of the loan assigned to the loan review queue and to receive user input indicating results of a review of the loan application; and
means for assigning the loan application to a second queue based on the received user input.

2. The system of claim 1, further comprising:
means for presenting a checklist of loan review conditions;
means for identifying a loan exception condition;
means for notifying the results of the loan review process; and
means for organizing loan review statistics.

3. A system for processing loan applications, comprising:
a database having loan application data associated with at least one loan application stored therein; and
a server having a processor, in communication with the database over a network, configured to obtain from the database the loan application data, the processor configured to assign the loan application to a loan review queue based on the loan application data;
wherein the server is configured to obtain a user input, over the network, from at least one client having a user interface configured to access the loan review queue and display loan application data of the loan assigned to the loan review queue and to receive user input indicating results of a review of the loan application; and
wherein the processor is configured to assign the loan application to a second queue based on the received user input.

4. The system of claim 3, wherein the processor is configured to assign the loan application to the loan review queue based on loan application data include at least one of (a) loan type, (b) branch, and/or (c) loan officer.

5. The system of claim 3, wherein the processor is further configured to generate a checklist of conditions for review of the loan.

6. The system of claim 5, wherein the checklist of conditions for review of the loan comprises at least one of (a) essential items, (b) required items, (c) general items, (d) collateral items, and/or (e) unsecured items.

7. The system of claim 5, wherein the processor is further configured to:
assign a point value to each of the conditions;
receive an indication whether each of the conditions has been satisfied;
determine an accumulated point value based on the indications of whether each of the conditions has been satisfied; and
assign the loan application to the second queue based on the accumulated point value.

8. The system of claim 3, wherein the second queue is a second loan review queue or a no exceptions queue.

9. The system of claim 3, wherein the processor is further configured to transmit, over the network, a notification indicating the results of the review of the loan application.

10. The system of claim 3, wherein the processor is further configured to collect, store, and organize loan review statistics.

11. The system of claim 10, the loan review statistics comprising at least one of loan officer, branch, loans originating with the loan officer or branch that have passed review without exception, loans fixed or adjusted during review, loans having explained exceptions, and/or outstanding loans requiring additional review.

12. A method for processing loan applications, comprising:
obtaining, by a server from a database over a network, loan application data associated with at least one loan application;
assigning, by a processor of the server, the loan application to a loan review queue based on the loan application data;
obtaining, by the server over the network, a user input from at least one client having a user interface configured to access the loan review queue and display loan application data of the loan assigned to the loan review queue and to receive user input indicating results of a review of the loan application; and
assigning, by the processor, the loan application to a second queue based on the received user input.

13. The method of claim 12, further comprising:
assigning, by the processor, the loan application to the loan review queue based on loan application data include at least one of (a) loan type, (b) branch, and/or (c) loan officer.

14. The method of claim 12, further comprising:
generating, by the processor, a checklist of conditions for review of the loan.

15. The method of claim 14, wherein the checklist of conditions for review of the loan comprises at least one of (a) essential items, (b) required items, (c) general items, (d) collateral items, and/or (e) unsecured items.

16. The method of claim 14, further comprising:
assigning, by the processor, a point value to each of the conditions;
receiving, by the processor, an indication whether each of the conditions has been satisfied;
determining, by the processor, an accumulated point value based on the indications of whether each of the conditions has been satisfied; and
assigning, by the processor, the loan application to the second queue based on the accumulated point value.

17. The method of claim 12, wherein the second queue is a second loan review queue or a no exceptions queue.

18. The method of claim 12, further comprising:
transmitting, by the processor over the network, a notification indicating the results of the review of the loan application.

19. The method of claim 12, further comprising:
collecting, storing, and organizing loan review statistics.

20. The method of claim 19, the loan review statistics comprising at least one of loan officer, branch, loans originating with the loan officer or branch that have passed review without exception, loans fixed or adjusted during review, loans having explained exceptions, and/or outstanding loans requiring additional review.
